(19) United States
(12) Patent Application Publication
(10) Pub. No.: US 2026/0321227 A1
(43) Pub. Date: Oct. 15, 2026

(54) A Device For Conducting Vibrations In String Instruments

(71) Applicant: James Soothill, Farnham (GB)

(72) Inventor: James Soothill, Farnham (GB)

(21) Appl. No.: 19/116,628

(22) PCT Filed: Sep. 28, 2023
(86) PCT No.: PCT/EP2023/076935

§ 371 Date: Mar. 28, 2025

(30) Foreign Application Priority Data
Sep. 28, 2022 (GB) 2214183.2

(51) Int. Cl. G10D 3/02; G10D 1/02

(52) U.S. Cl. CPC G10D 3/02; G10D 1/02

(57) ABSTRACT

A string instrument includes a front wall, a back wall opposite the front wall, and a sidewall disposed between the front wall and the back wall. The front wall, the back wall, and the sidewall define a cavity. The string instrument also includes a sound conduction spring positioned within the cavity. The sound conduction spring includes an elastic elongate member, a first end portion at a first end of the elastic elongate member, where the first end portion is coupled to an internal surface of the front wall, and a second end portion at a second end of the elastic elongate member opposite the first end, where the second end portion is coupled to an internal surface of the back wall.

### TECHNICAL FIELD

This disclosure relates to string instruments.

### BACKGROUND

Conventional string instruments typically comprise a cavity from which sound is produced. Some string instruments include a soundpost positioned within such a cavity.

FIGS. 1 to 3 depict a conventional violin 2. Violas, cellos, and basses have similar construction, but they have different scales. FIG. 1 is a schematic illustration (not to scale) showing a cross-sectional side view of the violin 2. FIG. 2 is a schematic illustration (not to scale) showing a cross-sectional top view of the violin 2. FIG. 3 is a schematic illustration (not to scale) showing a cross-sectional end view of the violin 2.

The violin 2 comprises a bridge 4, a soundpost 6, a front wall 8, a back wall 10, a sidewall 12, and a cavity 14 defined by the the front wall 8, the back wall 10, and the sidewall 12.

Typically, the violin 2 produces sound from the cavity 14. Particularly, sound is produced from the vibration of air within the cavity 14.

The bridge 4 is configured to hold the strings (not shown) of the violin 2. The strings are arranged along/parallel to the longitudinal axis of the violin 2.

The soundpost 6 is positioned very close to a position directly below one end of the bridge 4. The soundpost 6 couples to an interior surface of the front wall 8 at one end of the soundpost 6 and couples to an interior surface of the back wall 10 at the other end of the soundpost 6. The soundpost 6 is typically made of wood. The soundpost 6 is rigid.

To play the violin 2, i.e., produce sound from the violin 2, the strings are typically played with a bow. This causes the strings to vibrate. The displacement/vibration of the strings is translated to the front wall 8 by the bridge 4. Due to the soundpost 6 being positioned below one end of the bridge 4, the soundpost 6 acts as a pivot for the bridge 4, thereby causing the bridge 4 to rotate or pivot. The point of contact between the soundpost 6 and front wall 8 is the pivot point 16 about which the bridge 4 rotates or pivots. Thus, the bridge 4, when the violin 2 is played, rotates/pivots about the pivot point 16 (in the direction indicated as the double headed arrow with reference number 18 in FIG. 3). The rotation of the bridge 4 about the pivot point 16 vibrates the front wall 8. In other words, the rotation of the bridge 4 about the pivot point 16 increases the oscillation of the other end of the bridge 4, which transmits a vibration to the front wall 8. This vibration of the front wall 8 vibrates air within the cavity 14, thereby producing sound.

### SUMMARY

Violins and other string instruments have a mode of sound production that may be referred to as “breathing mode”. In the breathing mode the front wall 8 and back wall 10 bend outwards at the same time, and then bend inwards at the same time, similar to breathing. In the breathing mode the volume of cavity 14 increases and then subsequently decreases. In particular, the front wall 8 can be considered as to be having a vibration/displacement that is out of phase (e.g. 180° out of phase) with that of the back wall 10.

It is known from prior art such as CN 201222343 Y that a coil spring may be used to connect the front and back walls of a string instrument.

To achieve the 180° phase change between the front and back walls, it is preferable that the spring reacts quickly. For example, for playing a ‘middle C’ note, the spring will preferably bend and unbend about 262 times per second. Complex springs such as coil springs tend to react slowly, thereby providing undesirable characteristics for the purpose of phase change.

A leaf spring, such as that disclosed in KR 1020210148952 A1, is damped by the friction between the leaves. This is undesirable for operating a string instrument in a breathing mode.

The present inventor has realised that it would be beneficial to facilitate string instruments operating in the breathing mode.

In an aspect of the teachings herein, a string instrument is provided. The string instrument includes a front wall, a back wall opposite to the front wall, and a sidewall disposed between the front wall and the back wall. The front wall, the back wall, and the sidewall define a cavity. The string instrument further includes a sound conduction spring positioned within the cavity. The sound conduction spring includes an elastic elongate member, a first end portion at a first end of the elastic elongate member, the first end portion being coupled to an internal surface of the front wall, and a second end portion at a second end of the elastic elongate member opposite to the first end, the second end portion being coupled to an internal surface of the back wall.

The sound conduction spring may be positioned spaced apart from a bridge on an internal surface of the front wall. The sound conduction spring may be configured to transmit vibrations between the front wall and the back wall when the string instrument is played by a user. The sound conduction spring may be configured such that, when a vibration is transmitted between the front wall and the back wall via the sound conduction spring, the vibration at the front wall has a phase difference with the vibration at the back wall. The phase difference may be 180°.

The sound conduction spring may be positioned in the cavity at a position where, when the string instrument is played by a user, vibration of the front wall, the back wall, or both, may have a maximum amplitude/displacement.

The elastic elongate member may have a flexural modulus of less than or equal to 50,000 megapascals (MPa). At least one of the first end portion or the second end portion may have a cross-sectional area that is larger than a cross-sectional area of the elongate member in a plane perpendicular to a longitudinal direction of the elastic elongate member. The sound conduction spring may be in an interference fit between the front wall and the back wall. The sound conduction spring may be bent between the front wall and the back wall. At least one of the first end portion or the second end portion may be made of a material selected from the group of materials consisting of a wood, a softwood, cypress wood, a plastic, a polymer, and a metal. The first end portion and the second end portion may be made of the same material as each other. The first end portion and the second end portion may have the same shape as each other. The elastic elongate member may taper inwards at one or both of the first end and the second end. The elastic elongate member may have a cross-section in a plane perpendicular to a longitudinal direction of the elastic elongate member that has a shape of a circular segment.

The elastic elongate member may be made of a material selected from the group of materials consisting of an epoxy, a polyester, a plastic, a wood, a softwood, a metal, carbon or other reinforced composite material, and a glass reinforced plastic. The elastic elongate member may be a coil spring. The string instrument may be a bowed string instrument, for example a violin. The string instrument may comprise a soundpost positioned in the cavity and below one end of a bridge of the string instrument. The sound conduction spring may be positioned spaced apart from the soundpost. The soundpost may have lower elasticity than the sound conduction spring. The string instrument may be a plucked string instrument, for example a guitar. The sound conduction spring may be positioned spaced apart from a bridge of the guitar and between the bridge and a neck of the guitar.

In yet another aspect of the teachings herein, a sound conduction spring for use in a string instrument is provided. The sound conduction spring includes an elastic elongate member, a first end portion at a first end of the elongate member, and a second end portion at a second end of the elongate member, the second end being opposite to the first end.

The sound conduction spring of any preceding aspect may further includes a further elastic elongate member that is shorter than the elastic elongate member. The elastic elongate member and the further elastic elongate member may be both bent in a first direction. The further elastic elongate member may be attached to the elastic elongate member outside the bend of the elastic elongate member.

In yet another aspect of the teachings herein, an insertion device for inserting a sound conduction spring is provided. The insertion device includes a handle portion, and an insertion portion coupled to the handle portion, where the insertion portion includes a first arm, a second arm coupled to the first arm, and a third arm coupled to the second arm. The three arms are positioned in a W-shape. The second arm is offset from a plane defined by the first and third arm.

In yet another aspect of the teachings herein, a method of manufacturing a sound conduction spring is provided. The method includes providing a first elongate member and a second elongate member shorter than the first elongate member, applying a force to opposing ends of the first elongate member to curve/bend the first elongate member towards the first direction, and while force is being applied to the first elongate member, attaching the second elongate member to the first elongate member on the side of the first elongate member that is outside of the bend.

In yet another aspect of the teachings herein, a method of fitting a sound conduction spring into a string instrument is provided. The method includes positioning the sound conduction spring within a cavity of the string instrument such that the first end of the sound conduction spring is coupled to an interior surface of a front wall of a body of the string instrument, and the second end of the sound conduction spring is coupled to an interior surface of a back wall of a body of the string instrument, the back wall being opposite to the front wall.

The positioning may include interference fitting the sound conduction spring in the cavity. The method may further include determining, when the string instrument is being played by a user, a position on one or both of the front wall and the back wall corresponding to a maximum amplitude/displacement of vibration. The positioning of the sound conduction spring may include coupling the sound conduction spring to one or both of the front and back walls at the determined position.

### BRIEF DESCRIPTION OF THE DRAWINGS

FIG. 1 is a schematic illustration showing a cross-sectional side view of a conventional violin.

FIG. 2 is a schematic illustration showing a cross-sectional top view of the violin.

FIG. 3 is a schematic illustration showing a cross-sectional end view of the violin.

FIG. 4 is a schematic illustration showing a side view of a sound conduction spring.

FIG. 5 is a schematic illustration showing a cross-sectional end view of an elastic elongate member of the sound conduction spring.

FIG. 6 is a schematic illustration showing a cross-section side view of the elastic elongate member.

FIG. 7 is a schematic illustration showing a cross-sectional side view of the violin fitted with the sound conduction spring.

FIG. 8 is a schematic illustration showing a cross-sectional top view of the violin fitted with the sound conduction spring.

FIG. 9 is a schematic illustration showing a cross-sectional end view of the violin fitted with the sound conduction spring.

FIG. 10 is a schematic illustration showing a cross-sectional view of a guitar fitted with the sound conduction spring.

FIG. 11 is a schematic illustration showing a side view of a modified sound conduction spring.

FIG. 12A is a schematic illustration showing a first side view of an insertion device.

FIG. 12B is a schematic illustration showing a top down view of the insertion device;

FIG. 12C is a schematic illustration showing a side view of the insertion device holding the modified sound conduction spring.

FIG. 13 is a process flowchart showing certain steps of a method of inserting the modified sound conduction spring into a string instrument using the insertion device.

FIG. 14 is a process flowchart showing certain steps of a method of manufacturing the modified sound conduction spring.

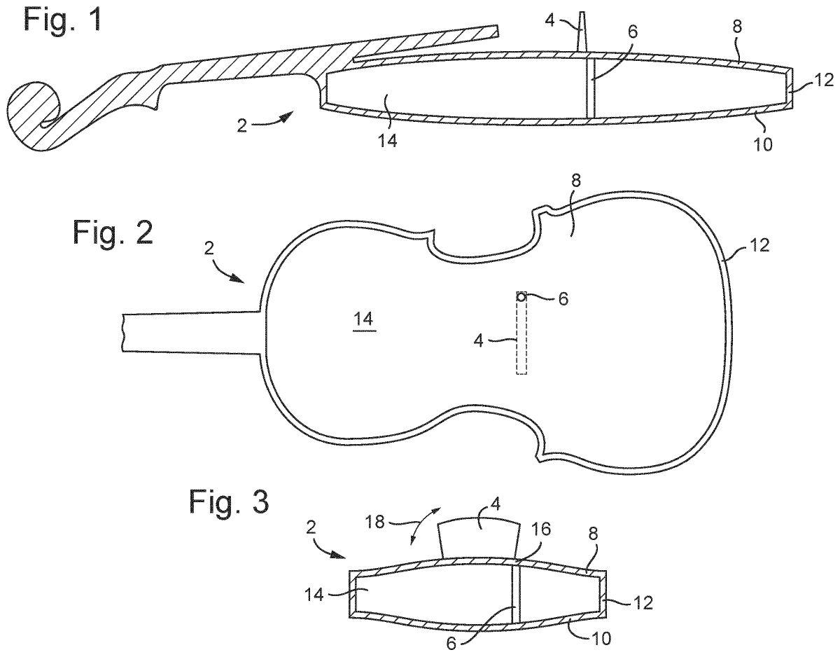

FIGS. 1-12C are not to scale.

### DETAILED DESCRIPTION

It will be appreciated that relative terms such as horizontal and vertical, top and bottom, upper and lower, above and below, front and back, and so on, are used below merely for ease of reference to the Figures, and these terms are not limiting as such, and any two differing directions or positions and so on may be implemented rather than truly horizontal and vertical, upper and lower, top and bottom, and so on.

FIG. 4 is a schematic illustration showing a side view of a sound conduction spring 20 for use in a string instrument. The sound conduction spring 20 shown is in an unbent state prior to being fitted into a string instrument.

The sound conduction spring 20 comprises an elastic elongate member 22, a first end portion 24, and a second end portion 26.

A length L of the sound conduction spring 20 may be dependent on application. In some embodiments, the length L is approximately 57 millimeters (mm).

The elastic elongate member 22 is an elongate member having a first end and a second end opposite to the first end.

In this embodiment, the elastic elongate member 22 is made of glass reinforced plastic.

In this embodiment, the elastic elongate member 22 has a modulus of elasticity of approximately 40,000 MPa.

In this embodiment, the elastic elongate member 22 bends when compressed.

The first end of the elongate member 22 is coupled to the first end portion 24. This coupling can be done by any appropriate means such as using adhesives or by an interference fit.

The second end of the elastic elongate member 22 is coupled to the second end portion 26. This coupling can be done by any appropriate means such as using adhesives or by an interference fit.

The first end portion 24 is made of a wood, such as a softwood, e.g., cypress. The grain of the wood is preferably substantially perpendicular to the length L. The cross-sectional area of the first end portion 24 is larger than the cross-sectional area of the elastic elongate member 22 in a plane perpendicular to the length L. In this embodiment, the cross-sectional shape of the first end portion 24 in a plane perpendicular to the length L is substantially rectangular or circular. In this embodiment, the shape of the second end portion may be substantially cuboidal or cylindrical.

The surface of the first end portion 24, which mates with the front wall, is covered with a high friction tape that is bonded to it with adhesive.

The second end portion 26 is made of a wood, such as a softwood, e.g., cypress.

The grain of the wood is preferably substantially perpendicular to the length L. The cross-sectional area of the second end portion 26 is larger than the cross-sectional area of the elastic elongate member 22, in a plane perpendicular to the length L. In this embodiment, the cross-sectional shape of the second end portion 26 in a plane perpendicular to the length L is substantially rectangular or circular. In this embodiment, the shape of the second end portion may be substantially cuboidal or cylindrical.

The second end portion 26 may be substantially identical to the first end portion 24. The surface of the second end portion 26 which mates with the back wall is covered with a high friction tape that is bonded to it with adhesive.

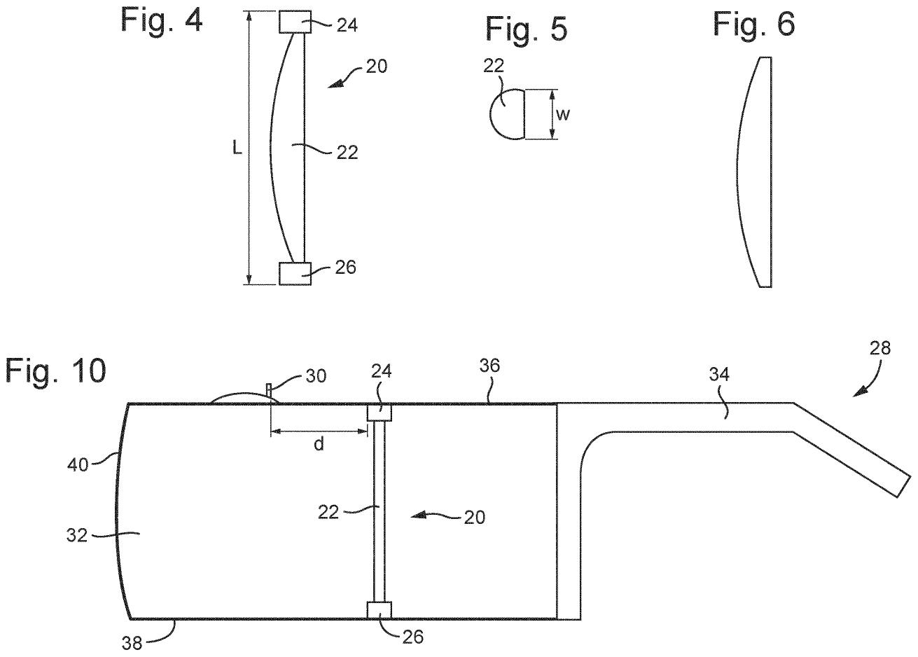

FIG. 5 is a schematic illustration showing a cross-sectional view of the elastic elongate member 22 taken in a plane perpendicular to length L. The shape of the cross-section of the elastic elongate member 22 is that of a circular segment, e.g., semi-circle, or a flat rectangle. A circular segment is a region of a circle that is “cut off” from the rest of the circle by a secant or a chord. A maximum width W of the elastic elongate member 22 is approximately 2 mm.

FIG. 6 is a schematic illustration showing a side view cross section of the elastic elongate member 22 in a plane parallel to length L. The elastic elongate member 22 is tapered inwards along its longitudinal direction at the first and second ends, i.e., the thickness of the elongate member at its ends is smaller than the thickness at its middle.

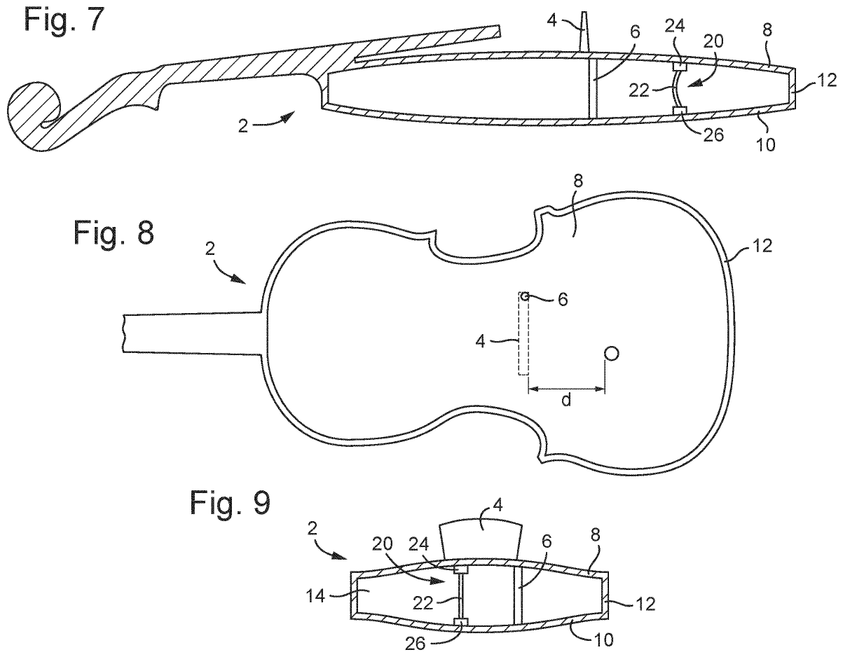

FIGS. 7 to 9 show the violin 2 fitted with the sound conduction spring 20. In particular, FIG. 7 is a schematic illustration showing a side cross-sectional view of the violin 2 with the sound conduction spring 20 in the cavity 14. FIG. 8 is a schematic illustration showing a top cross-sectional view of the violin 2 with the sound conduction spring 20 in the cavity 14. FIG. 9 is a schematic illustration showing an end cross-sectional view of the violin 2 with the sound conduction spring 20 in the cavity 14.

In this embodiment, the sound conduction spring 20 is positioned within the cavity 14 of the violin 2. The sound conduction spring 20 is positioned spaced apart from the bridge 4 and/or the soundpost 6. This means that the sound conduction spring 20 is not directly below the bridge 4. In this embodiment, a distance d between the sound conduction spring 20 and the bridge 4 (specifically, an end of the bridge 4 opposite to the end of the bridge 4 that is above the soundpost 6) in a direction towards a bottom of the violin 2 is approximately 60 mm.

In this embodiment, the sound conduction spring 20 is further positioned approximately 5 mm from a bass bar (not shown) of the violin 2 in a direction towards a central longitudinal axis of the violin.

In this embodiment, the sound conduction spring 20 is in an interference fit between the interior surface of the front wall 8 and the interior surface of the back wall 10. Also, the sound conduction spring 20 is in a bent state, i.e., the elongate member 22 is curved, when the sound conduction spring 20 is fitted in the violin 2. As such, when fitted into the violin 2, the sound conduction spring 20 applies an outwards force to the front and back walls 8, 10. The sound conduction spring 20 may be bent during and/or before fitting into the violin 2. The length L may be around 2 mm greater than the distance between the front and back walls 8, 10 of the violin 2.

The first end portion 24 is coupled to (specifically engaged with or in contact with) the interior surface of the front wall 8. The distal end of the first end portion 24 has a shape such that it mates with the internal surface of the front wall 8. The distal end of the first end portion 24 has a shape such that it conforms with the internal surface of the front wall 8.

The second end portion 26 is coupled to (specifically engaged with or in contact with) the interior surface of the back wall 10. The distal end of the second end portion 26 has a shape such that it mates with the internal surface of the back wall 10. The distal end of the second end portion 26 has a shape such that it conforms with the internal surface of the back wall 10.

When the violin 2 with the sound conduction spring 20 is played by a user, the strings of the violin 2 vibrate. This vibration is transferred to the front wall 8 via the bridge 4, as described in more detail above with reference to FIGS. 1-3. Thus, the front wall 8 vibrates. The sound conduction spring 20 transfers, transmits, or conducts the vibration of the front wall 8 to the back wall 10. Thus, in this embodiment, the back wall 10 also vibrates. This advantageously tends to improve the sound quality and/or the volume of the violin 2.

In this embodiment, when the violin 2 is played by a user, the vibrations of the front wall 8 at the first end portion 24 are out of phase, at least to some extent, with the vibrations of the back wall 10 at the second end portion 26. Preferably, the vibrations of the front wall 8 at the first end portion 24 are 180° out of phase, with the vibrations of the back wall 10 at the second end portion 26. This effect tends to be provided for by the elasticity, size, and/or shape of the elongate member 22. Advantageously, an elongate member 22 having such elasticity, size, and shape tends to allow the violin 2 to operate in the breathing mode (i.e., ensuring that the vibrations of the front wall 8 at the first end portion 24 are 180° out of phase with the vibrations of the back wall 10 at the second end portion 26).

In other words, the sound conduction spring 20 is configured to receive a vibration of the front and/or back wall resulting from the violin 2 being played. The elastic elongate member 22 has an elasticity such that a sound wave travelling along the length L will experience a phase change as it travels along the length L. For example, if the first end portion 24 receives a sound wave with a phase Φ1, then the sound wave at the second end portion 26, having travelled along the sound conduction spring 20, may have a phase Φ2, where Φ2 may be out of phase with Φ1, e.g., Φ1-Φ2≠0°(preferably about 180°). In other words, the sound wave that travels from the first end portion 24 to the second end portion 26 experiences a phase delay.

In contrast to the elastic elongate member 22, if a sound wave produced from the string instrument being played travels along the soundpost 6, it may not experience the same phase change.

Thus, the sound conduction spring 20 advantageously tends to promote the vibrations of the front and back walls 8, 10 being approximately 180° out of phase with each other. Thus, the playing of the violin 2 in a breathing mode (which may be desirable to many players) is facilitated.

In one example, to achieve a 180° phase difference between the front and back walls during operation of the string instrument playing a ‘middle C’ note, it is preferable that the sound conduction spring 20 oscillates about 262 times per second. In other words, the sound conduction spring 20 will preferably bend and unbend about 262 times per second. Advantageously, the sound conduction spring 20 having such elasticity, size, and shape as described above tends to provide faster reaction to vibrations compared to other springs such as coil springs, thereby providing the necessary characteristics to facilitate the string instrument to operate in a breathing mode.

As described above, when the violin is played by a user, the front and/or back walls vibrate. Preferably, the sound conduction spring 20 is located at a position of maximum vibration amplitude. For example, the first end portion 24 may be coupled to the front wall 8 at or proximate to the point of maximum vibration amplitude of the front wall 8. Also, for example, the second end portion 26 may be coupled to the back wall 10 at or proximate to the point of maximum vibration amplitude of the back wall 10. This tends to provide for improved performance.

The sound conduction spring 20 is configured to conduct vibrations/sound waves from the front wall 8 to the back wall 10 and/or vice versa.

Advantageously, the asymmetrical/circular segment cross sectional shape of the elongate member tends to allow for the control of where the elastic elongate member bends to when compressed.

Advantageously, the inwardly tapered end of the elastic elongate member tends to allow the stress experienced along the elastic elongate member to be substantially uniform when the elastic elongate member bends/compresses.

Advantageously, the first and/or second end portions having a cross-sectional area larger than the elastic elongate member tends to reduce damage to the string instrument when the sound conduction spring is fitted therein.

Advantageously, the distal end of the first end portion having a shape such that the front end portion mates with the internal surface of the front wall tends to facilitate an improved coupling between the sound conduction spring and the front wall.

Advantageously, the distal end of the second end portion having a shape such that the second end portion mates with the internal surface of the back wall tends to facilitate an improved coupling between the sound conduction spring and the back wall.

Advantageously, the first end portion having a shape that conforms with the internal surface of the front wall tends to facilitate improved stress distribution and thereby reduces damage to the front wall.

Advantageously, the second portion having a shape that conforms with the internal surface of the back wall tends to facilitate improved stress distribution and thereby reduces damage to the back wall.

Advantageously, the sound conduction spring having a length L about 2 mm greater than the distance between the front and back walls tends to facilitate an effective interference fit of the sound conduction spring between the front and back walls.

Advantageously, the sound conduction spring positioned at the point where the front wall has maximum amplitude during vibrations allows for more effective transmission of the vibrations between the front and back walls.

Advantageously, the sound conduction spring positioned at the point where the back wall has maximum amplitude during vibrations allows for more effective transmission of the vibrations between the front and back walls.

Advantageously, a violin comprising the sound conduction spring tends to facilitate the operation of the violin in the breathing mode.

In the above embodiments, the length L of the sound conduction spring is approximately 57 mm. In other embodiments, the sound conduction spring has a different length, e.g., a length of less than 57 mm, or greater than 57 mm. Example lengths may include but are not limited to at least 70 mm, at least 65 mm, at least 60 mm, at least 55 mm, at least 50 mm, at least 45 mm, at least 40 mm, at least 35 mm, at least 30 mm, or at least 25 mm.

In the above embodiments, the sound conduction spring is in an unbent state prior to fitting. In other embodiments, the sound conduction spring may be in a bent state prior to fitting. In other words, the sound conduction spring may have a bent shape in an uncompressed state. In some embodiments, the sound conduction spring may be bent during the manufacturing process. In some embodiments, the uncompressed sound conduction spring defines a substantially U-shape or a substantially V-shape. Advantageously, the sound conduction spring having a bent shape in an uncompressed state provides the necessary characteristics, e.g., length L of the sound conduction spring, to promote the vibrations at the front and back walls to be approximately 180° out of phase with each other for string instruments with shorter distances between the front and back walls. This arrangement facilitates the string instrument to be played in a ‘breathing’ mode.

In some embodiments, the sound conduction spring may additionally comprise a string configured to maintain the sound conduction spring in a partially bent state prior to fitting. The string may be coupled to the first end portion at a first end and coupled to the second end portion at a second end. Advantageously, the string tends to make the installation of the sound conduction spring easier because the sound conduction spring may be appropriately bent prior to fitting. Advantageously, the string tends to reduce the risk of damage to the walls of the string instrument that may be caused by the sound conduction spring.

In the above embodiments, the sound conduction spring is bent into an interference fit between the interior surface of the front wall and the interior surface of the back wall. In other embodiments, the sound conduction spring is not bent in an interference fit between the interior surface of the front wall and the interior surface of the back wall.

In the above embodiments, the sound conduction spring comprises both the first and second end portions. In other embodiments, the sound conduction spring does not comprise both the first and second end portions. In some embodiments, the first end portion is omitted, the second end portion is omitted, or both of the end portions, are omitted.

In the above embodiments, the elastic elongate member is made of glass reinforced plastic, e.g., with the fibres orientated along the length of the elastic elongate member. In other embodiments, the elastic elongate member is made of a different type of material. Example materials include but are not limited to an epoxy, a polyester, a plastic, a wood, carbon or other reinforced composite material, and a metal. In some embodiments, the elastic elongate member is a coil spring.

In the above embodiments, the elastic elongate member has a flexural modulus of approximately 40,000 MPa. In other embodiments, the elastic elongate member has a different flexural modulus, for example, the elastic elongate member has a flexural modulus of approximately less than or equal to 3000 MPa, less than or equal to 10,000 MPa, less than or equal to 20,000 MPa, less than or equal to 30,000 MPa, less than or equal to 50,000 MPa, less than or equal to 60,000 MPa, less than or equal to 70,000 MPa, less than or equal to 80,000 MPa, or greater than or equal to 90,000 MPa.

In the above embodiments, the elastic elongate member bends when compressed. In other embodiments, the elastic elongate member does not bend when compressed.

In the above embodiments, the first and/or second portions are made of wood. In other embodiments, one or both of the first end portion and the second end portion is made of a different material, such as a plastic or a rubber or a high-friction plastic.

In the above embodiments, the first and/or second portions are covered with a high friction tape. In other embodiments, first and/or second portions are not covered with a high friction tape, e.g., the high friction tape is omitted. In some embodiments, the first and/or second portions may be covered with another high friction coating, such as rubber, or a glue that sets upon cooling.

Use of rubber on the first and/or second portions may improve elasticity of the end portions, and thus the device.

In the above embodiments, the grain of the wood is substantially perpendicular to the longitudinal direction of the elastic elongate member. In other embodiments, the grain of the wood is not substantially perpendicular to the longitudinal direction of the elastic elongate member, e.g., the grain may be parallel to the longitudinal direction of the elastic elongate member.

In the above embodiments, the first and second end portions are identical. In other embodiments, the first and second end portions are not identical.

In the above embodiments, the cross-sectional area of the first and second end portions is larger than the cross-sectional area of the elastic elongate member. In other embodiments, the cross-sectional area of one or both of the first and second end portions is smaller than or equal to the cross-sectional area of the elastic elongate member.

In the above embodiments, the cross-sectional shape of the first and/or second end portions is substantially rectangular or circular. In other embodiments, the cross-sectional shape of the first and/or second end portions is non-rectangular or non-circular.

In the above embodiments, the elastic elongate member has a maximum width of 2 mm. In other embodiments, the elastic elongate member has a different size maximum width, e.g., at least 1 mm, at least 1.5 mm, at least 2 mm, at least 2.5 mm, at least 3 mm, at least 3.5 mm, at least 4 mm, at least 4.5 mm, or at least 5 mm.

In the above embodiments, the shape of the cross-section of the elastic elongate member is that of a circular segment. In the other embodiments, the cross-section of the elastic elongate member has a different shape.

In the above embodiments, the elastic elongate member is tapered at both its ends. In other embodiments, the elastic elongate member is not tapered at one or both of its ends.

In the above embodiments, the distance d between the sound conduction spring and the bridge is approximately 60 mm. In other embodiments, the distance d is a different value, e.g., d may be less than or equal to 120 mm, less than or equal to 110 mm, less than or equal to 100 mm, less than or equal to 90 mm, less than or equal to 80 mm, less than or equal to 70 mm, less than or equal to 60 mm, less than or equal to 50 mm, less than or equal to 40 mm, less than or equal to 30 mm, less than or equal to 20 mm, or less than or equal to 10 mm. In any embodiment, the distance d may be in a direction that is head side of the bridge or tail side of the bridge.

In the above embodiments, the distance between the sound conduction spring and a bass bar of the violin is approximately 5 mm. In other embodiments, the distance between the sound conduction spring and a bass bar of the violin is a different value, for example approximately 1 mm to 20 mm, 5 mm to 15 mm, 7 mm to 12 mm, 2 mm, 4 mm, 5 mm, 6 mm, 8 mm, or 10 mm.

In the above embodiments, the string instrument is a violin. In other embodiments, the string instrument is not a violin. In other embodiments, the string instrument is bowed stringed instrument such as a cello, a viola, a double bass, a viol, or a lyra.

In other embodiments, the string instrument is a plucked string instrument such as an ukulele, a guitar, or a lute.

FIG. 10 is a schematic illustration showing a cross-sectional side view of a guitar fitted with a sound conduction spring.

The guitar 28 comprises a bridge 30, a cavity 32, a neck 34, a front wall 36, a back wall 38, a sidewall 40, and the sound conduction spring 20. The sidewall 40 extends from the front wall 36 to the back wall 38. The front wall 36, the back wall 38, and the sidewall 40 define the cavity 32. The guitar 28 differs from the violin in that guitars tend to not comprise a soundpost.

In this embodiment, the sound conduction spring 20 is positioned spaced apart from the bridge 30, i.e., not directly below the bridge 30. The sound conduction spring 20 is positioned neckward of the bridge 30, i.e., between the bridge 30 and the neck 34. For example, the distance d between the sound conduction spring 20 and the bridge 30 in a plane perpendicular to the length L is 5 mm and 30 mm trebleside from the highest pitch strings or 30 mm bass side from the lowest pitched string.

Preferably, the sound conduction spring 20 is located at a position of maximum vibration amplitude of the walls 36, 38. For example, the first end portion 24 may be coupled to the front wall 36 at or proximate to the point of maximum vibration amplitude of the front wall 36. Also, for example, the second end portion 26 may be coupled to the back wall 38 at or proximate to the point of maximum vibration amplitude of the back wall 38. This tends to provide for improved performance.

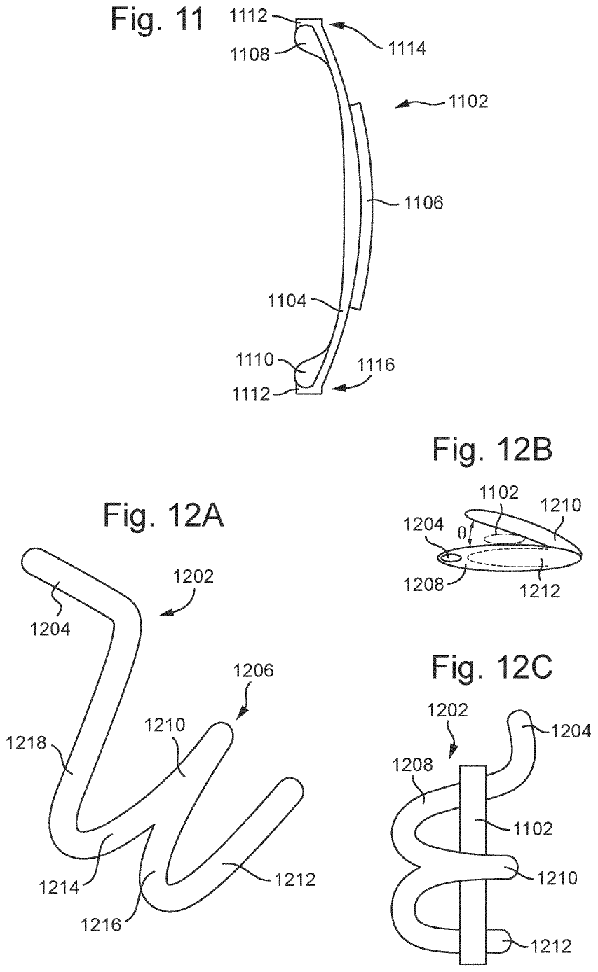

FIG. 11 is a schematic illustration showing a side view of a modified sound conduction spring 1102 for use in a string instrument, e.g., a cello. The modified sound conduction spring 1102 comprises a first elongate member 1104, a second elongate member 1106, a first end portion 1108, a second end portion 1110, and relatively high friction regions 1112. The first elongate member 1104 extends along a longitudinal axis, e.g., the vertical dimension. The first elongate member 1104 comprises a first end 1114 and a second end 1116 opposite to the first end 1114. The first elongate member 1104 is curved/bent in a first direction. The first direction is perpendicular to the longitudinal axis.

In this embodiment, the first elongate member 1104 is made from a glass reinforced polymer, e.g., a glass reinforced plastic. Preferably, the glass fibres of the glass reinforced polymer are aligned such that they are substantially parallel to the curved/bent shape of the first elongate member 1104. In other words, the glass fibres are orientated along the length of the modified sound conduction spring 1102. The curve/bend can be considered a reflex bend of about 12°, i.e., the angle between a line formed from the first or second end 1114, 1116 of the first elongate member 1104 to the turning point of the curve/bend (e.g. mid-point) and the longitudinal axis (vertical dimension) is about 12°. The reflex bend is a bend in the opposite direction to the bend that will occur when the device is inserted into the instrument.

The second elongate member 1106 is curved/bent in the first direction. In this way, the second elongate member 1106 has a shape that conforms to the first elongate member 1104. The second elongate member 1106 is coupled to the first elongate member 1104. In this embodiment, the second elongate member 1106 is adhered with epoxy to the first elongate member 1104 across a major surface of the second elongate member 1106. The first elongate member 1104 has a side that faces towards the first direction (i.e., the direction of the curve/bend) and an opposing side that faces away from the first direction (i.e., towards the second direction). The second elongate member 1106 is attached to the side of the first elongate member 1104 that is facing towards the first direction. In other words, the second elongate member 1106 is coupled to the first elongate member 1104 on the side of the first elongate member 1104 that is outside of the curve/bend of the first elongate member 1104. The glass fibres in the first elongate member 1104 are pre-stressed during manufacture, whereby the glass fibres are subjected to tension whilst the plastic is setting. The curved/bent shape of the first elongate member 1104 is achieved by subjecting the first elongate member 1104 to tension whilst the second elongate member 1106 is being attached to the first elongate member 1104. When using epoxy resin as an adhesive between the first and second elongate members 1104, 1106, the first elongate member 1104 is forced into the bent/curved shaped while the epoxy resin is setting.

In this embodiment, the second elongate member 1106 is made from a glass reinforced polymer, e.g., a glass reinforced plastic. Preferably, the glass fibres of the glass reinforced polymer are aligned such that they are substantially parallel to the curved/bent shape of the second elongate member 1106. In other words, the glass fibres are orientated along the length of the modified sound conduction spring 1102. Similar to the first elongate member 1104, the glass fibres in the second elongate member 1106 are pre-stressed during manufacture where the glass fibres are subjected to tension whilst the plastic is setting. The curved/bent shape of the second elongate member 1106 is achieved by subjecting the second elongate member 1106 to tension whilst the second elongate member 1106 is being attached to the first elongate member 1104. The curve/bend of the second elongate member 1106 can be considered a reflex bend of 12°, i.e., the angle between a line formed from one of the opposing ends of the second elongate member 1106 to the turning point of the curve/bend (e.g. mid-point) of the second elongate member 1106 and the longitudinal axis (vertical dimension) is about 12°.

The length of the unbent/uncurved second elongate member 1106 is about ⅓ of the length of the unbent/uncurved first elongate member 1104. A midpoint between the opposing ends of the second elongate member 1106 is at a position that is about 5/13 of the total length of the unbent/uncurved first elongate member 1104 from the first end 1114 of the first elongate member 1104. In this embodiment, the first and second elongate members 1104, 1106, e.g., two strips of glass reinforced plastic laminates, are bent at the time of bonding so that after bonding a reflex bend of 12 degrees occurs absent any external forces.

The thickness of the second elongate member 1106 is approximately the same as the thickness of the first elongate member 1104. The second elongate member 1106 is made from the same material as the first elongate member 1104.

The modified sound conduction spring 1102 is thicker at regions with both the first and second elongate members 1104, 1106. There is a reflex bend of 12° in the portions where the first and second elongate members 1104, 1106 are both present.

The first end portion 1108 is coupled to the first end 1114 of the first elongate member 1104. The first end portion 1108 is made from wood. The first end portion 1108 is orientated such that the grain of the wood is substantially perpendicular to the orientation of the glass fibres of the first elongate member 1104. In this embodiment, the cross-sectional shape of the first end portion 1108 in a plane perpendicular to the longitudinal axis is substantially rectangular.

The second end portion 1110 is coupled to the second end 1116 of the first elongate member 1104. The second end portion 1110 is made from wood. The second end portion 1110 is orientated such that the grain of the wood is substantially perpendicular to the orientation of the glass fibres of the first elongate member 1104. In this embodiment, the cross-sectional shape of the second end portion 1110 in a plane perpendicular to the longitudinal axis is substantially rectangular.

The first and second end portions 1108, 1110, are attached to the first elongate member 1104. The side of the first elongate member 1104 on which the first and second end portions 1108, 1110, are attached to is opposite to the side of the first elongate member 1104 that the second elongate member 1106 is attached to.

The relatively high friction regions 1112 are each configured to contact and mate with a respective one of the front and back walls of a string instrument. In this embodiment, the relatively high friction regions 1112 are each formed from a high friction tape. When the modified sound conduction spring 1102 is fitted in a string instrument (e.g., a cello or violin), the relatively high friction regions 1112 contact/are braced against the front and back walls of the string instrument. In some embodiments, each of the relatively high friction regions 1112 may be orientated at 45° to the longitudinal axis.

The overall length L, i.e., the length in the direction of the longitudinal axis, of the modified sound conduction spring 1102 is approximately 157 mm. This tends to allow for the modified sound conduction spring 1102 to be used in a cello. For other instruments the overall length can be different. The overall length L may be around 17 mm greater than the distance between the front and back walls of the string instrument, e.g., a cello.

In this embodiment, a maximum width, i.e., the width of the modified sound conduction spring at the positions where the first elongate member 1104 is attached to the second elongate member, is approximately 4.8 mm.

In this embodiment, the modified sound conduction spring 1102 has a flexure modulus of approximately 40,000 MPa.

FIG. 12A is a schematic illustration showing a side view of an insertion device.

The insertion device 1202 comprises a handle portion 1204 and an insertion portion 1206. The insertion portion 1206 is W-shaped. The insertion portion 1206 comprises a first arm 1208, second arm 1210, and third arm 1212. The first arm 1208 extends from the handle portion 1204 to the second arm, thereby coupling the handle portion 1204 to the second arm 1210.

The second arm 1210 is substantially V-shaped. The second arm 1210 comprises a first branch 1214 coupled to a second branch 1216 such that the first branch 1214 is at an angle of less than 180° relative to the second branch 1216. The first branch 1214 is coupled to the first arm 1208. The second branch 1216 is coupled to the third arm 1212.

In this embodiment, the insertion device 1202 is made from metal wire. In some embodiments, the insertion device 1202 may be coated with a paint, a rubber coating, or a tube (including a heat shrink tube). Such a coating may both help protect the instrument from damage, and help increase the friction between the device and the applicator, thereby facilitating insertion.

FIG. 12B is a schematic illustration showing a top down view of the insertion device with the modified sound conduction spring 1102 and the third arm 1212 shown in phantom. FIG. 12C is a schematic illustration showing the side view of the insertion device 1202 holding the modified sound conduction spring 1102. The modified sound conduction spring 1102 shown in FIG. 12C has been simplified for clarity.

The three arms 1208, 1210, 1212 are positioned into a substantially W-shape. The second arm is at an offset angle θ to a plane defined by the first and third arms 1208, 1212.

The offset angle is 0°<θ90°, e.g., 20°.

The insertion device 1202 is configured to hold the modified sound conduction spring 1102 between the second arm 1210 and the first and third arms 1208, 1212. The space between the second arm 1210 and the first and third arms 1208, 1212 is sized to receive the modified sound conduction spring 1102. When the modified sound conduction spring 1102 is inserted into the insertion device 1202, i.e., being held by the insertion device 1202, the second elongate member 1106 contacts the second arm 1210, and the first elongate member 1104 contacts the first and third arms 1208, 1212.

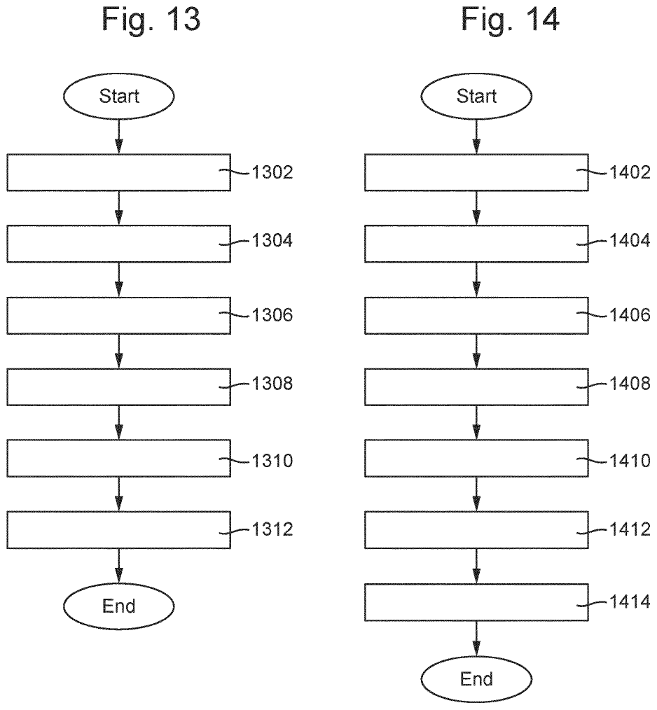

FIG. 13 is a process flowchart showing certain steps of a method of inserting the modified sound conduction spring 1102 into a string instrument using the insertion device 1202.

At step s1302, the modified sound conduction spring 1102 is bent in the second direction, thereby straightening the modified sound conduction spring 1102. The second direction is opposite to the first direction (i.e., the direction in which the first and second elongate member 1104, 1106 are curved/bent towards).

At step s1304, the modified sound conduction spring 1102 is held by the arms 1208, 1210, 1212 of the insertion device 1202 by positioning the straightened modified sound conduction spring 1102 between the second arm 1210 and the first and third arms 1208, 1212. In other words, the modified sound conduction spring 1102 is positioned so that the second elongate member 1106 contacts the second arm 1210 and the first elongate member 1104 contacts the first and third arms 1208, 1212.

At step s1306, the insertion device 1202 is positioned so that the insertion portion 1204 of the insertion device 1202 holding the modified sound conduction spring 1102 is positioned within the cavity of the string instrument. Specifically, the insertion device 1202 can be orientated such that the modified sound conduction spring 1102 can fit through an opening to the cavity of the string instrument (typically positioned on the front wall of the string instrument). This can be done by a user, holding the handle portion 1204 of the insertion device 1202, twisting or rotating the insertion device 1202. Once in the appropriate orientation the insertion portion 1206 holding the modified sound conduction spring 1102 can be inserted into the cavity of the instrument through the opening while the handle portion 1204 remains outside of the cavity of the string instrument. This allows the user to manipulate the orientation and position of the modified sound conduction spring 1102 inside the cavity from the outside of the cavity. In the case of a cello, the modified sound conduction spring 1102 is positioned at a distance of approximately 150 mm from the bridge of the cello. More preferably, the modified sound conduction spring 20 is further positioned approximately 7 mm from a bass bar of the cello in a direction towards a central longitudinal axis of the cello.

At step s1308, the insertion device 1202 is orientated so that the relatively high friction portions 1112 contact opposing walls, e.g., the front and back walls, of the string instrument. In this way, the modified sound conduction spring 1102 is braced against the opposing walls, i.e., is held in an interference fit between the opposing front and back walls of the string instrument.

At step s1310, the insertion device 1202 is rotated while the modified sound conduction spring 1102 is braced against the opposing walls such that the modified sound conduction spring 1102 is further bent in the second direction. In this way, the modified sound conduction spring 1102 becomes spaced apart from the first and/or third arms 1210, 1212, thereby detaching the modified sound conduction spring 1102 from the insertion device 1202.

At step s1312, the insertion device 1202, without the modified sound conduction spring 1102, is removed from the cavity of the string instrument. Specifically, once the modified sound conduction spring 1102 is detached from the insertion device 1202, the user may move, using the handle portion 1204, the insertion device 1202 away from the modified sound conduction spring 1102 that is braced against the opposing walls so that the insertion device 1202 is separated from the modified sound conduction spring 1102. Once the insertion device 1202 is separated from the modified sound conduction spring 1102, the user can remove the insertion device 1202 from the cavity through the opening.

The modified sound conduction spring 1102 can also be removed from the string instrument by performing reverse operation of the method of FIG. 13.

FIG. 14 is a process flowchart showing certain steps of a method of manufacturing the modified sound conduction spring 1102.

At step s1402, a first elongate member 1104 and a second elongate member 1106 are provided. The second elongate member 1106 is shorter than the first elongate member 1104.

At step s1404, a force is applied to the first and second ends 1114, 1116 of the first elongate member 1104 so that the first elongate member 1104 is bending towards the first direction. While the force is being applied to the first elongate member 1104, the first elongate member 1104 is in a stressed state.

At step s1406, while in the stressed state, the second elongate member 1106 is adhered to a side of the first elongate member 1104 that is outside of the curve/bend of the first elongate member 1104. In this way, the glass fibres in the first elongate member 1104 are subjected to tension whilst the adhesive cures.

At step s1408, the first end portion 1108 is attached to the first end 1114 of the first elongate member 1104.

At step s1410, the second end portion 1110 is attached to the second end 1116 of the first elongate member 1104.

At step s1412, a relatively high friction region is formed at the first end 1114 of the first elongate member 1104.

At step s1414, another relatively high friction region is formed at the second end 1116 of the first elongate member 1106.

Advantageously, the modified sound conduction spring tends to improve the sound of string instruments, e.g., cellos, particularly the bass notes.

Advantageously, the modified sound conduction spring tends to reduce/eliminate the occurrence of wolf notes without spoiling the tone of the cello. Some instruments have one or more wolf notes that are dead spots where instead of a solid tone a thin “surface” sound is produced. This problem is particularly prevalent in cellos. Conventional methods of removing wolf notes tend to spoil the tone of the cello.

Advantageously, the second elongate member providing an increase in the thickness at the mid-portion tends to increase strength without adding significant weight.

Advantageously, fibres of the first and/or second elastic elongate member orientated along its length tend to greatly increase the bending strength of the elastic elongate member.

Advantageously, positioning the shorter second elongate member near the centre of the first elongate member allows the stress experienced along the modified sound conduction spring to be substantially uniform when the modified sound conduction spring bends/compresses.

Advantageously, the placing of the second elongate member so that it is closer to the belly than the back when fitted facilitates the fitting process.

Advantageously, the 12° reflex bend in the sound conduction spring allows it to be a more effective conductor of vibrations when bent into position.

Advantageously, the placing of the second elongate member on the outside of the reflex bend decreases the chance that the modified sound conduction spring will delaminate whilst in use.

Advantageously, the fibres in the first and/or second elongate member are pre-stressed during its manufacture. This tends to increase strength and speed of reaction to vibrations.

Advantageously, the second elongate member facilitates deforming the first elongate member into the curve/bent shape.

Advantageously, the first and/or second end portions tend to increase the contact surface of the modified sound conduction spring, thereby improving the transfer of force from/to walls of the string instrument.

Advantageously, the first and/or second end portions tend to increase the friction between the modified sound conduction spring and the walls of the string instrument.

Advantageously, the high friction tape tends to improve the installation of the modified sound conduction spring within the cavity of the string instrument. The high friction tape covering the mating surfaces of the first and second end portions tends to facilitate fitting and reduces the chance that the spring will fall out of position.

Advantageously, the first and second end portions being fixed to the side of the first elongate member that is opposite to the side to which the second elongate member is attached tend to enhance the reflex bend, thus allowing the sound conduction spring to be a more effective conductor of vibrations when bent into position.

Advantageously, the modified sound conduction spring having a length (along the longitudinal axis, e.g., vertical dimension) of about 17 mm greater than the distance between the front and back walls tends to facilitate an effective interference fit of the sound conduction spring between the front and back walls and to ensure that the spring, when fitted, is bent in the opposite direction to the reflex bend.

Advantageously, an instrument comprising the modified sound conduction spring tends to facilitate the operation of the instrument in its breathing mode.

Advantageously, the insertion device tends to make the installation of the modified sound conduction spring easier because the insertion device allows the user to manipulate the modified sound conduction spring in a cavity into a greater range of positions and/or orientations from the outside of the cavity.

Advantageously, the insertion device made from metal wire tends to make the installation of the modified sound conduction spring easier because the metal wire allows the user to further bend the insertion device to facilitate the insertion of the sound conduction spring into unusually shaped string instruments.

Advantageously, the insertion device being coated with a paint, rubber, or tube tends to make the installation of the modified sound conduction spring easier because the coating increases the friction between the insertion device and the sound conduction spring. Advantageously, the coating further protects the string instrument from damage during the insertion process.

In the above embodiments, the modified sound conduction spring is for cellos and the length (along the longitudinal direction, e.g., vertical dimension) of the modified sound conduction spring is approximately 157 mm. In other embodiments, the modified sound conduction spring is for a different string instrument and has a different length (along the longitudinal direction, e.g., vertical dimension), e.g., a length of less than 157 mm or greater than 157 mm. In other embodiments, the modified sound conduction spring is for cellos but has a length (along the longitudinal direction, e.g., vertical dimension) that is not 157 mm, e.g., is 180 mm to 175 mm, 175 mm to 165 mm, 165 mm to 160 mm, 160 mm to 155 mm, 155 mm to 150 mm, 150 mm to 145 mm, 145 mm to 140 mm, 140 mm to 135 mm, 135 mm to 130 mm, 130 mm to 125 mm, 125 mm to 120 mm, 120 mm to 115 mm, 115 mm to 110 mm, and 110 mm to 105 mm.

In the above embodiments, the modified sound conduction spring has a flexural modulus of approximately 40,000 MPa. In other embodiments, the modified sound conduction spring has a different flexural modulus, for example, the modified sound conduction spring has a flexural modulus of approximately less than or equal to 3000 MPa, less than or equal to 10,000 MPa, less than or equal to 20,000 MPa, less than or equal to 30,000 MPa, less than or equal to 50,000 MPa, less than or equal to 60,000 MPa, less than or equal to 70,000 MPa, less than or equal to 80,000 MPa, or greater than or equal to 90,000 MPa.

In the above embodiments, the relatively high friction regions are formed by applying high friction tape to surfaces at opposite ends of the modified sound conduction spring. However, in other embodiments, the relatively high friction regions are formed from means other than using high friction tapes, e.g., surface modifications such as knuckled surfaces, or a high friction coating, or making the end portions from a high friction plastic.

In the above embodiments, the first and second elongate members are glued together with epoxy. However, in other embodiments, the first and second elongate members are attached to each other by means other than being glued together with epoxy, e.g., glues or adhesives other than epoxy, screws, cement, or magnets.

In the above embodiments, the first elongate member is made from a strip of glass reinforced polymer. However, in other embodiments, the first elongate member is made from materials other than glass reinforced polymer, e.g., a wood, a metal, or a plastic.

In the above embodiments, the glass fibres of the first elongate member are aligned parallel to the curve/bent shape of the first elongate member. However, in other embodiments, the glass fibres of the first elongate member are aligned in a way other than being parallel to the curve/bent shape of the first elongate member, e.g., the glass fibres of the first elongate member are aligned perpendicular to the curve/bent shape of the first elongate member.

In the above embodiments, the first and/or second elongate members have a reflex bend of 12°. However, in other embodiments, the first and/or second elongate members have a different reflex bend, e.g. 20° to 25°, 15° to 20°, 10° to 15°, 5° to 10°, or less than 5°.

In the above embodiments, the first and second elongate members have the same thickness. However, in other embodiments, the first and second elongate members have different thicknesses to each other.

In the above embodiments, the modified sound conduction spring comprises both the first and second end portions. However, in other embodiments, the modified sound conduction spring does not comprise both the first and second end portions, e.g., the modified sound conduction spring may comprise only the first end portion, or the modified sound conduction spring may omit the first and second end portions.

In the above embodiments, the modified sound conduction spring has a maximum width of 4.8 mm. In other embodiments, the modified sound conduction spring has a different sized maximum width, e.g., 1 mm to 1.5 mm, 1.5 mm to 2 mm, 2 mm to 2.5 mm, 2.5 mm to 3 mm, 3 mm to 3.5 mm, 3.5 mm to 4 mm, 4 mm to 4.5 mm, 4.5 mm to 5 mm, 5 mm to 6 mm, 6 mm to 6.5 mm, 6.5 mm to 7 mm, 7 mm to 7.5 mm, 7.5 mm to 8 mm, 8 mm to 8.5 mm, 8.5 mm to 9 mm, 9 mm to 9.5 mm, 9.5 mm to 10 mm, 10 mm to 10.5 mm, and 10.5 mm to 11 mm.

In the above embodiments, the shape of the cross-section of the modified sound conduction spring is that of a rectangle. However, in other embodiments, the cross-section of the modified sound conduction spring has a different shape.

In the above embodiments, the modified sound conduction spring has a reflex bend of 12 degrees. However, in other embodiments, the modified sound conduction spring has no reflex bend or has a reflex bend of less than or equal to 1 degree, less than or equal to 6 degrees, less than or equal to 9 degrees, less than or equal to 12 degrees, less than or equal to 15 degrees, less than or equal to 18 degrees, less than or equal to 21 degrees, less than or equal to 24 degrees, or more than 24 degrees.

In the above embodiments, when installed, the distance d between the sound conduction spring and the bridge is approximately 150 mm. In other embodiments, the distance d is a different value, e.g., d may be less than or equal to 300 mm, less than or equal to 280 mm, less than or equal to 260 mm, less than or equal to 240 mm, less than or equal to 220 mm, less than or equal to 200 mm, less than or equal to 180 mm, less than or equal to 160 mm, less than or equal to 140 mm, less than or equal to 110 mm, less than or equal to 90 mm, or less than or equal to 70 mm. In any embodiment, the distance d may be in a direction that is head side of the bridge or tail side of the bridge.

In the above embodiments, the distance between the sound conduction spring and a bass bar of the cello is approximately 7 mm. In other embodiments, the distance between the sound conduction spring and a bass bar of the cello is a different value, for example approximately 1 mm to 120 mm, 5 mm to 15 mm, 7 mm to 12 mm, 2 mm, 4 mm, 5 mm, 6 mm, 8 mm, or 10 mm.

In the above embodiments, the insertion device is made from metal wire. In other embodiments, the insertion device is made from a material other than metal wire.

In the above embodiments, the insertion device is coated with a paint, a rubber coating, or a tube. In other embodiments, the insertion device is not provided with a coating, e.g., the coating is omitted.

In the above embodiments, the string instrument is a violin or cello. In other embodiments, the string instrument is not a violin or cello. In other embodiments, the string instrument is bowed stringed instrument such as a cello, a viola, a double bass, a viol, or a lyra.

Further aspects of the invention are provided by the subject matter of the following clauses:
1. A string instrument comprising:
a front wall;
a back wall opposite to the front wall;
a sidewall disposed between the front wall and the back wall, wherein the front wall, the back wall, and the sidewall define a cavity; and
a sound conduction spring positioned within the cavity, the sound conduction spring comprising:
   an elastic elongate member;
   a first end portion at a first end of the elastic elongate member, the first end portion being coupled to (e.g. abutting) an internal surface of the front wall; and
   a second end portion at a second end of the elastic elongate member opposite to the first end, the second end portion being coupled to (e.g. abutting) an internal surface of the back wall.
2. The string instrument according to clause 1, wherein the sound conduction spring is positioned spaced apart from a bridge on an internal surface of the front wall.
3. The string instrument according to clause 1 or clause 2, wherein the sound conduction spring is configured to transmit vibrations between the front wall and the back wall when the string instrument is played by a user.
4. The string instrument according to clause 3, wherein the sound conduction spring is configured such that, when a vibration is transmitted between the front wall and the back wall via the sound conduction spring, the vibration at the front wall has a phase difference with the vibration at the back wall; more preferably the phase difference is 180°.
5. The string instrument according to any of clauses 1 to 4, wherein the sound conduction spring is positioned in the cavity at a position where, when the string instrument is played by a user, vibration of the front and/or back wall has a maximum amplitude.
6. The string instrument according to any of clauses 1 to 5, wherein the elastic elongate member has a flexural modulus of less than or equal to 50,000 MPa.
7. The string instrument according to any of clauses 1 to 6, wherein at least one of the first and second end portions has a cross-sectional area larger than a cross-sectional area of the elongate member in a plane perpendicular to a longitudinal direction of the elastic elongate member.
8. The string instrument according to any of clauses 1 to 7, wherein the sound conduction spring is in an interference fit between the front wall and the back wall.
9. The string instrument according to any of clauses 1 to 8, wherein the sound conduction spring is bent between the front wall and the back wall.
10. The string instrument according to any of clauses 1 to 9, wherein at least one of the first and second end portions is made of a material selected from the group of materials consisting of: a wood, a softwood, cypress wood, a plastic, a polymer, and a metal.
11. The string instrument according to any of clauses 1 to 10, wherein the first and second end portions are made of the same material as each other.
12. The string instrument according to any of clauses 1 to 11, wherein the first and second end portions have the same shape as each other.
13. The string instrument according to any of clauses 1 to 12, wherein the elastic elongate member tapers inwards at one or both of the first end and the second end.
14. The string instrument according to any of clauses 1 to 13, wherein the elastic elongate member has a cross-section in a plane perpendicular to a longitudinal direction of the elastic elongate member that has a shape of a circular segment.
15. The string instrument according to any of clauses 1 to 14, wherein the elastic elongate member is made of a material selected from the group of materials consisting of: an epoxy, a polyester, a plastic, a wood, a softwood, a metal, or carbon or other reinforced composite material, and glass reinforced plastic.
16. The string instrument according to any of clauses 1 to 15, wherein the elastic elongate member is a coil spring.
17. The string instrument according to any of clauses 1 to 16, wherein the string instrument is a bowed string instrument, for example a violin; more preferably: the string instrument comprises a soundpost positioned in the cavity and below one end of a bridge of the string instrument; the sound conduction spring is positioned spaced apart from the soundpost; and the soundpost has lower elasticity than the sound conduction spring.
18. The string instrument according to any of clauses 1 to 16, wherein the string instrument is a plucked string instrument, for example a guitar; more preferably the sound conduction spring is positioned spaced apart from a bridge of the guitar and between the bridge and a neck of the guitar.
19. A sound conduction spring for use in a string instrument, the sound conduction spring comprising: an elastic elongate member; a first end portion at a first end of the elongate member; and a second end portion at a second end of the elongate member, the second end being opposite to the first end.
20. The sound conduction spring of clause 19, further comprises a further elastic elongate member that is shorter than the elastic elongate member; wherein: the elastic elongate member and the further elastic elongate member are both bent in a first direction; and the further elastic elongate member is attached to the elastic elongate member outside the bend of the elastic elongate member.
21. An insertion device for inserting a sound conduction spring, the insertion device comprising: a handle portion; an insertion portion coupled to the handle portion, the insertion portion comprises a first arm, a second arm coupled to the first arm, and a third arm coupled to the second arm, wherein the three arms are positioned in a W-shape, and wherein the second arm is offset from a plane defined by the first and third arm.
22. A method of manufacturing a sound conduction spring, the method comprising: providing a first elongate member and a second elongate member shorter than the first elongate member; applying a force to opposing ends of the first elongate member to curve/bend the first elongate member towards the first direction; and while force is being applied to the first elongate member, attaching the second elongate member to the first elongate member on the side of the first elongate member that is outside of the bend.
23. A method of fitting a sound conduction spring into a string instrument, the method comprising: positioning the sound conduction spring within a cavity of the string instrument such that: the first end of the sound conduction spring is coupled to an interior surface of a front wall of a body of the string instrument; and the second end of the sound conduction spring is coupled to an interior surface of a back wall of a body of the string instrument, the back wall being opposite to the front wall.
24. The method according to clause 23, wherein the positioning comprises interference fitting the sound conduction spring in the cavity.
25. The method according to clause 23 or clause 24, further comprising determining, when the string instrument is being played by a user, a position on one or both of the front and back walls corresponding to a maximum amplitude of vibration; wherein the positioning of the sound conduction spring comprises coupling the sound conduction spring to one or both of the front and back walls at the determined position.
26. A string instrument comprising: a front wall; a back wall opposite to the front wall, wherein the front wall and the back wall define a cavity therebetween; and a sound conduction spring positioned within the cavity, the sound conduction spring comprising: an elastic elongate member; a first end portion at a first end of the elastic elongate member, the first end portion being coupled to (e.g. abutting) an internal surface of the front wall; and a second end portion at a second end of the elastic elongate member opposite to the first end, the second end portion being coupled to (e.g. abutting) an internal surface of the back wall; wherein the elastic elongate member is configured such that, in use, the elastic elongate member deflects away from a longitudinal axis, the longitudinal axis being defined as a straight line connecting the first end portion to the second end portion.
27. The string instrument according to any preceding clause, wherein the elastic elongate member is shaped such that the elastic elongate member defines a substantially arcuate shape, a substantially V shape, or a substantially U shape.
28. The string instrument according to any preceding clause, wherein the sound conduction spring is positioned spaced apart from a bridge on an internal surface of the front wall.
29. The string instrument according to any preceding clause, wherein the sound conduction spring is configured to transmit vibrations between the front wall and the back wall when the string instrument is played by a user.
30. The string instrument according to any preceding clause, wherein the sound conduction spring is configured such that, when a vibration is transmitted between the front wall and the back wall via the sound conduction spring, the vibration at the front wall has a phase difference with the vibration at the back wall.
31. The string instrument according to any preceding clause, wherein the phase difference is 180°.
32. The string instrument according to any preceding clause, wherein the sound conduction spring is positioned in the cavity at a position where, when the string instrument is played by a user, vibration of the front and/or back wall has a maximum amplitude.
33. The string instrument according to any preceding clause, wherein the elastic elongate member has a flexural modulus of less than or equal to 50,000 MPa.
34. The string instrument according to any preceding clause, wherein at least one of the first and second end portions has a cross-sectional area larger than a cross-sectional area of the elongate member in a plane perpendicular to a longitudinal direction of the elastic elongate member.
35. The string instrument according to any preceding clause, wherein the sound conduction spring is in an interference fit between the front wall and the back wall.
36. The string instrument according to any preceding clause, wherein at least one of the first and second end portions is made of a material selected from the group of materials consisting of: a wood, a softwood, cypress wood, a plastic, a polymer, and a metal.
37. The string instrument according to any preceding clause, wherein the first and second end portions are made of the same material as each other.
38. The string instrument according to any preceding clause, wherein at least one of the first and second end portions has a substantially circular or rectangular cross-section in a plane perpendicular to the longitudinal axis.
39. The string instrument according to any preceding clause, wherein the first and second end portions have the same shape as each other.
40. The string instrument according to any preceding clause, wherein the sound conduction spring further comprises a string coupled to the first end portion at a first end and coupled to the second end portion at a second end, and wherein the string is configured to maintain the sound conduction spring in a partially bent state.
41. The string instrument according to any preceding clause, wherein the elastic elongate member tapers inwards at one or both of the first end and the second end.
42. The string instrument according to any preceding clause, wherein the elastic elongate member has a cross-section in a plane perpendicular to a longitudinal direction of the elastic elongate member that has a shape of a circular segment, a circle, or an oval.
43. The string instrument according to any preceding clause, wherein the elastic elongate member is made of a material selected from the group of materials consisting of: an epoxy, a polyester, a plastic, a wood, a softwood, a metal, or carbon or other reinforced composite material, and glass reinforced plastic.
44. The string instrument according to any preceding clause, wherein the string instrument is a bowed string instrument, for example a violin; more preferably: the string instrument comprises a soundpost positioned in the cavity and below one end of a bridge of the string instrument; the sound conduction spring is positioned spaced apart from the soundpost; and the soundpost has lower elasticity than the sound conduction spring.
45. The string instrument according to any preceding clause, wherein the string instrument is a plucked string instrument, for example a guitar; more preferably the sound conduction spring is positioned spaced apart from a bridge of the guitar and between the bridge and a neck of the guitar.
46. A sound conduction spring for use in a string instrument, the sound conduction spring comprising: an elastic elongate member; a first end portion at a first end of the elastic elongate member; and a second end portion at a second end of the elastic elongate member opposite to the first end; wherein the elastic elongate member is configured such that, in use, the elastic elongate member deflects away from a longitudinal axis, the longitudinal axis being defined as a straight line connecting the first end portion to the second end portion.
47. A sound conduction spring according to any preceding clause, further comprising a further elastic elongate member coupled to the elastic elongate member.
48. A sound conduction spring according to any preceding clause, wherein the further elastic elongate member is of complimentary shape to the elastic elongate member and coupled along its length thereto.
49. A sound conduction spring according to any preceding clause, wherein: the further elastic elongate member is shorter in length to the elastic elongate member; the elastic elongate member and the further elastic elongate member are both bent in a first direction; and the further elastic elongate member is attached to the elastic elongate member outside the bend of the first elastic elongate member.
50. An insertion device for inserting a sound conduction spring, the insertion device comprising: a handle portion; an insertion portion coupled to the handle portion, the insertion portion comprises a first arm, a second arm coupled to the first arm, and a third arm coupled to the second arm, wherein the three arms are positioned in a W-shape, and wherein the second arm is offset from a plane defined by the first and third arm.
51. A method of manufacturing a sound conduction spring, the method comprising: providing a first elongate member and a second elongate member shorter than the first elongate member; applying a force to opposing ends of the first elongate member to curve/bend the first elongate member towards the first direction; and while force is being applied to the first elongate member, attaching the second elongate member to the first elongate member on the side of the first elongate member that is outside of the bend.
52. A method of fitting a sound conduction spring into a string instrument, the method comprising: positioning the sound conduction spring within a cavity of the string instrument such that: the first end of the sound conduction spring is coupled to an interior surface of a front wall of a body of the string instrument, the coupling being an interference fit; and the second end of the sound conduction spring is coupled to an interior surface of a back wall of a body of the string instrument, the back wall being opposite to the front wall, and the coupling being an interference fit.
53. The method according to the preceding clause, further comprising determining, when the string instrument is being played by a user, a position on one or both of the front and back walls corresponding to a maximum amplitude of vibration; wherein the positioning of the sound conduction spring comprises coupling the sound conduction spring to one or both of the front and back walls at the determined position.

1. A string instrument comprising:
a front wall;
a back wall opposite to the front wall, wherein the front wall and the back wall define a cavity therebetween; and
a sound conduction spring positioned within the cavity, the sound conduction spring comprising:
an elastic elongate member;
a first end portion at a first end of the elastic elongate member, the first end portion being coupled to an internal surface of the front wall; and
a second end portion at a second end of the elastic elongate member opposite to the first end, the second end portion being coupled to an internal surface of the back wall; wherein
the elastic elongate member is configured such that, in use, the elastic elongate member deflects away from a longitudinal axis, the longitudinal axis being defined as a straight line connecting the first end portion to the second end portion.

2. The string instrument according to claim 1, wherein the elastic elongate member is shaped such that the elastic elongate member defines a substantially arcuate shape, a substantially V shape, or a substantially U shape.

3. The string instrument according to claim 1, wherein the sound conduction spring is positioned spaced apart from a bridge on an internal surface of the front wall.

4. The string instrument according to claim 1, wherein
the sound conduction spring is configured to transmit vibrations between the front wall and the back wall when the string instrument is played by a user; and
the sound conduction spring is configured such that, when a vibration is transmitted between the front wall and the back wall via the sound conduction spring, the vibration at the front wall has a phase difference of 180° with the vibration at the back wall.

5. (canceled)

6. (canceled)

7. The string instrument according to claim 1, wherein the sound conduction spring is positioned in the cavity at a position where, when the string instrument is played by a user, vibration of at least one of the front wall or the back wall has a maximum amplitude.

8. The string instrument according to claim 1, wherein the elastic elongate member has a flexural modulus of less than or equal to 50,000 MPa.

9. The string instrument according to claim 1, wherein at least one of the first and second end portions has a cross-sectional area larger than a cross-sectional area of the elongate member in a plane perpendicular to a longitudinal direction of the elastic elongate member.

10. The string instrument according to claim 1, wherein the sound conduction spring is in an interference fit between the front wall and the back wall.

11. (canceled)

12. The string instrument according to claim 1, wherein the first and second end portions are made of a same material as each other.

13. The string instrument according to claim 1, wherein at least one of the first and second end portions has a substantially circular or rectangular cross-section in a plane perpendicular to the longitudinal axis.

14. The string instrument according to claim 1, wherein the first end portion and the second end portion have a same shape as each other.

15. The string instrument according to claim 1, wherein the sound conduction spring further comprises a string coupled to the first end portion at a first end and coupled to the second end portion at a second end, and wherein the string is configured to maintain the sound conduction spring in a partially bent state.

16. The string instrument according to claim 1, wherein the elastic elongate member tapers inwards at one or both of the first end and the second end.

17. The string instrument according to claim 1, wherein the elastic elongate member has a cross-section in a plane perpendicular to a longitudinal direction of the elastic elongate member that has a shape of a circular segment, a circle, or an oval.

18. (canceled)

19. The string instrument according to claim 1, wherein the string instrument is a bowed string instrument; and
the string instrument comprises a soundpost positioned in the cavity and below one end of a bridge of the string instrument;
the sound conduction spring is positioned spaced apart from the soundpost; and
the soundpost has lower elasticity than the sound conduction spring.

20. The string instrument according to claim 1, wherein the string instrument is a plucked string instrument, and
the sound conduction spring is positioned spaced apart from a bridge of the plucked string instrument and between the bridge and a neck of the plucked string instrument.

21. A sound conduction spring for use in a string instrument, the sound conduction spring comprising:
an elastic elongate member;
a first end portion at a first end of the elastic elongate member; and
a second end portion at a second end of the elastic elongate member opposite to the first end; wherein
the elastic elongate member is configured such that, in use, the elastic elongate member deflects away from a longitudinal axis, the longitudinal axis being defined as a straight line connecting the first end portion to the second end portion.

22. (canceled)

23. (canceled)

24. (canceled)

25. An insertion device for inserting a sound conduction spring, the insertion device comprising:
a handle portion; and
an insertion portion coupled to the handle portion, the insertion portion comprises a first arm, a second arm coupled to the first arm, and a third arm coupled to the second arm, wherein the first arm, the second arm, and the third arm are positioned in a W-shape, and wherein the second arm is offset from a plane defined by the first and third arm.

26. A method of manufacturing the sound conduction spring of claim 21, wherein the elastic elongate member comprises a first elongate member and a second elongate member shorter than the first elongate member, the method comprising:
applying a force to opposing ends of a first elongate member to curve/bend the first elongate member towards a first direction; and
while force is being applied to the first elongate member, attaching the second elongate member to the first elongate member on a side of the first elongate member that is outside of the bend.

27. A method of fitting the sound conduction spring into the string instrument of claim 1, the method comprising:
determining, when the string instrument is being played by a user, a position on at least one of the front wall and the back wall of the string instrument that corresponds to a maximum amplitude of vibration;
positioning the sound conduction spring within the cavity of the string instrument such that:
the first end portion of the sound conduction spring is coupled to the internal surface of the front wall by an interference fit; and
the second end of the sound conduction spring is coupled to the internal surface of the back wall by an interference fit;
wherein positioning the sound conduction spring comprises coupling the sound conduction spring to the at least one of the front wall or the back wall at the position.

28. (canceled)
